(19) United States
(12) Patent Application Publication
(10) Pub. No.: US 2011/0157070 A1
(43) Pub. Date: Jun. 30, 2011

(54) SYSTEM AND METHOD FOR CONFIGURING CAPACITIVE SENSING SPEED

(75) Inventors: BRADLEY MARTIN, AUSTIN, TX (US); YONGHONG TAO, SINGAPORE (SG)

(73) Assignee: SILICON LABORATORIES INC., AUSTIN, TX (US)

(21) Appl. No.: 12/651,152

(22) Filed: Dec. 31, 2009

(51) Int. Cl. G06F 3/045; H02J 7/00

(52) U.S. Cl. 345/174; 320/166

(57) ABSTRACT

A system and method for configuring capacitive sensing speed are provided. In one example, a circuit includes first and second circuitry and control logic. The first circuitry controls a first current provided to a reference capacitor having a known capacitance. The second circuitry controls a second current to an external capacitor having an unknown capacitance. The control logic is configured to receive input defining a period of time at which to set the charge time of the reference capacitor, control the first circuitry to provide a minimum amount of the first current needed to charge the reference capacitor within the defined period of time, and control the second circuitry to provide an amount of the second current needed to normalize the charge time of the external capacitor with the charge time of the reference capacitor.

### CROSS-REFERENCE TO RELATED APPLICATIONS

This application is related to U.S. patent application Ser. No. 12/494,417, filed on Jun. 30, 2009, entitled SYSTEM AND METHOD FOR DETERMINING CAPACITANCE VALUE (Atty. Dkt. No. CYGL-29,111), U.S. patent application Ser. No. 12/146,349, filed on Jun. 25, 2008, entitled LCD CONTROLLER CHIP (Atty. Dkt. No. CYGL-28,970), co-pending U.S. patent application Ser. No. ______, filed Dec. 31, 2009, entitled TOUCH SCREEN POWER-SAVING SCREEN SCANNING ALGORITHM (Atty. Dkt. No. CYGL-29,762), and co-pending U.S. patent application Ser. No. ______, filed Dec. 31, 2009, entitled CAPACITIVE SENSOR WITH VARIABLE CORNER FREQUENCY FILTER (Atty. Dkt. No. CYGL-29,799), all of which are incorporated herein by reference in their entirety.

### TECHNICAL FIELD

The present invention relates to programmable current values for use in a touch capacitive sensing system, and more particularly, to a system and method for programming current values to modify the speed at which touch capacitor sensing occurs.

### BACKGROUND

Electronic circuit design often requires the use of various interface circuitries such as capacitive sensor arrays that enable the user to interact with or receive information from an electronic circuit. Typically, dedicated sensing circuitry may be used to detect the activation of various capacitive switches within a capacitive sensor array enabling a user to input particular information into a circuit.

Within a capacitive sensor array there is needed the ability to detect differences in the capacitance value of a capacitive switch responsive to the placement of an object upon or in the proximity of the capacitive switch. Current technologies lack flexibility in how such changes are determined and improvements are needed.

### SUMMARY

The present invention, as disclosed and described herein, in one aspect thereof, comprises a circuit for determining a value of a variable capacitor. First circuitry controls a first current provided to a reference capacitor having a known capacitance, wherein the first current determines a charge time defining an amount of time required for the first current to fully charge the reference capacitor and wherein alteration of the first current alters the charge time of the reference capacitor. Second circuitry controls a second current to an external capacitor having an unknown capacitance, wherein the second current determines a charge time of the external capacitor and wherein alteration of the second current alters the charge time of the external capacitor. Control logic is configured to receive input defining a period of time at which to set the charge time of the reference capacitor, control the first circuitry to provide a minimum amount of the first current needed to charge the reference capacitor within the defined period of time, and control the second circuitry to provide an amount of the second current needed to normalize the charge time of the external capacitor with the charge time of the reference capacitor.

### BRIEF DESCRIPTION OF THE DRAWINGS

For a more complete understanding, reference is now made to the following description taken in conjunction with the accompanying Drawings in which:

FIG. 1A illustrates an overall diagram of a scan control IC interface with a touch screen;

FIG. 1B illustrates a more detailed diagram of the scan control IC illustrating the two scan functions;

FIG. 1C illustrates a more detailed diagram of the logic of the scan control IC;

FIG. 2 illustrates a diagrammatic view of the scan control IC interface with a touch screen and the port mapping functions;

FIG. 2A illustrates a diagrammatic view of the port mapping functions;

FIG. 3 is an upper level block diagram of one embodiment of an integrated circuit containing controller functionality coupled to the capacitive array of FIG. 1 via a multiplexer;

FIG. 4A is a diagram of one embodiment of an idealized transmission line that may form a row in the capacitive array of FIG. 1;

FIG. 4B is a graph illustrating changes in sensed capacitance as resistance increases along the transmission line of FIG. 4A;

FIG. 5A is a functional block diagram of one embodiment of capacitive touch sense circuitry that may be used to detect capacitance changes in the capacitive array of FIG. 1;

FIG. 5B illustrates a block diagram of one embodiment of analog front end circuitry of the capacitive touch sense circuitry of FIG. 5A;

FIG. 6A is a diagram of one embodiment of current control circuitry that may be located in the analog front end circuitry of FIG. 5B that may be used with an external capacitor;

FIG. 6B is a diagram of one embodiment of current control circuitry that may be located in the analog front end circuitry of FIG. 5B that may be used with a reference capacitor;

FIG. 6C is a diagram of one embodiment of current control circuitry that may be located in the analog front end circuitry of FIG. 5B;

FIG. 7A is a flow chart illustrating one embodiment of a scanning process that may be performed using aspects of the present disclosure;

FIG. 7B is a flow chart illustrating one embodiment of a method for setting a scanning speed in the analog front end circuitry of FIG. 5B;

FIG. 8 is a flow chart illustrating another embodiment of a method for setting a scanning speed in the analog front end circuitry of FIG. 5B;

FIG. 9A is a diagram illustrating one embodiment of a touch screen;

FIG. 9B is a diagram illustrating another embodiment of the touch screen of FIG. 9A;

FIG. 10A illustrates a diagrammatic view of the MTR module interfaced with a touch screen; and

FIG. 10B illustrates a simplified diagram of the MTR circuit.

### DETAILED DESCRIPTION

Referring now to the drawings, wherein like reference numbers are used herein to designate like elements throughout, the various views and embodiments of a capacitive touch sensor are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

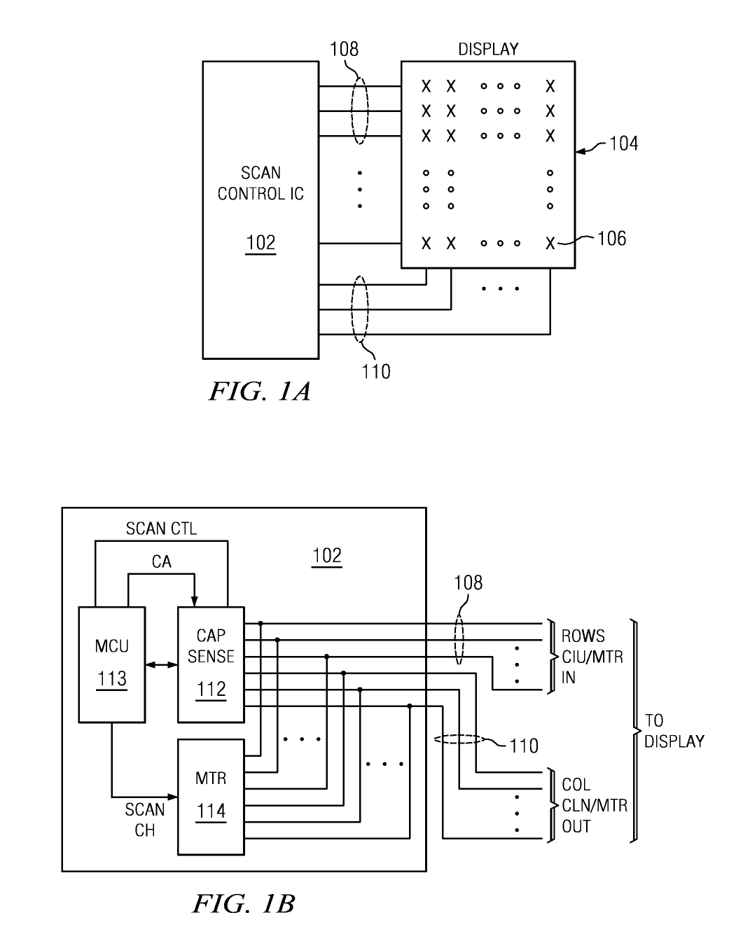

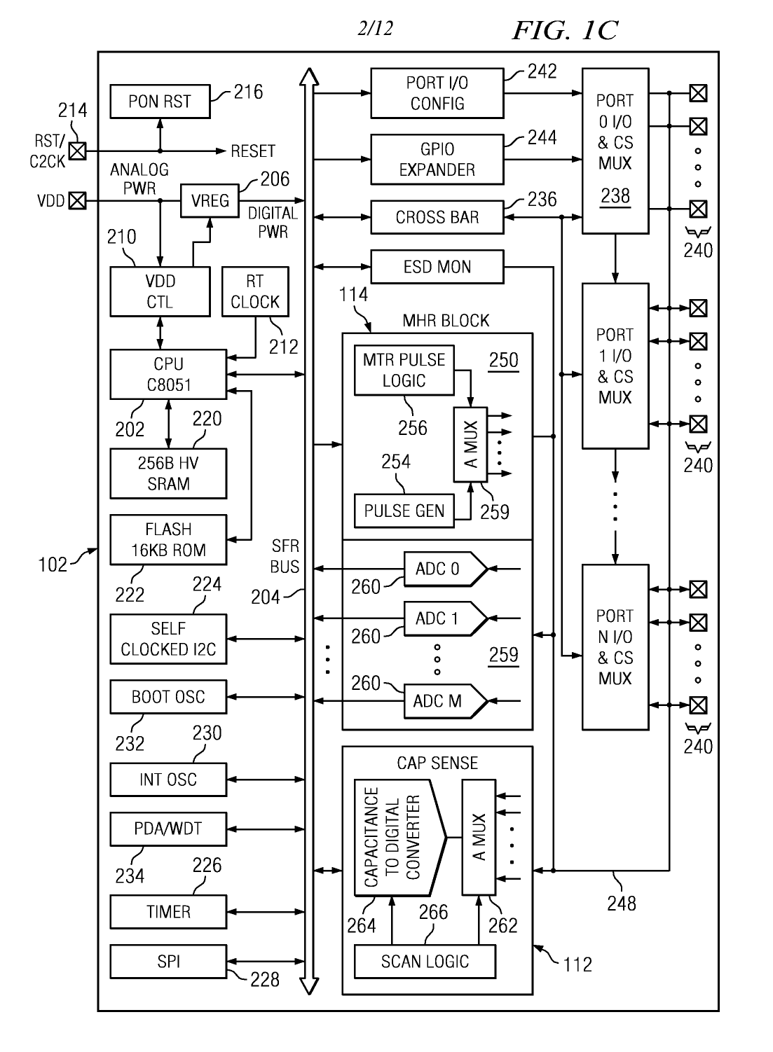

Referring now to FIG. 1A, there is illustrated a diagrammatic view of a scan control IC 102 that is interfaced with a touch screen 104 that can be used by itself or in conjunction with a display as an overlay. The touch screen 104 is a touch screen having a plurality of distributed capacitors 401 disposed at intersections of columns and rows. There are a plurality of rows 108 and a plurality of columns 110 interfaced with the scan control IC. Thus, a row line will be disposed across each row which intersects with a column line on the touch screen surface and these are interfaced with the scan control IC 102. It should be understood that a capacitive touch pad refers to an area on the touch screen, but will be used to refer to an intersection between a row line and a column line. The term “touch pad” and “intersection” shall be used interchangeably throughout.

As will be described herein below, the self capacitance of a particular row or a particular column in one mode is evaluated by determining the capacitance that is associated with a particular row or column line, this being an external capacitance. Any change to this capacitance will be sensed and evaluated, this change being due to such things as a finger touching an area of the touch screen 104. By sensing both the row and the column lines and determining the self capacitance associated therewith, the particular capacitive touch pad 106 (or area of the touch screen) touched can be determined which will be indicated by an increase in capacitance on a row and a column line (for a single touch). In another mode, mutual capacitance between the intersection of a row and a column is determined.

Referring now to FIG. 1B, there is illustrated a more detailed diagrammatic view of the scan control IC 102. In determining a change in capacitance at a particular for a particular row or column line, there can be multiple techniques utilized. The first technique is to merely sense the value of the self capacitance for all or a select one or ones of the row or column lines and then utilize some type of algorithm to determine if the capacitance value has changed and then where that change occurred, i.e., at what intersection of row and column lines. The scan control IC 102 provides this functionality with a capacitive sense block 112. This block 112 just determines if a change has occurred in the self capacitance value of the particular row or column line to ground. Another technique is that referred to as a “multi-touch resolve” (MTR) functionality provided by a functional block 114. This is for sensing changes in the mutual capacitance at the intersection of a row and column line. The cap sense block 112 is basically controlled to scan row and column lines and determine the self capacitance thereof to ground. If a change in the self capacitance occurs, this indicates that some external perturbance has occurred, such as a touch. By evaluating the self capacitance values of each of the rows and columns and compare them with previously determined values, a determination can be made as to where on the touch screen a touch has been made. However, if multiple touches on the touch screen have occurred, this can create an ambiguity. The MTR module 114, as will be described in more detail herein below, operates to selectively generate a pulse or signal on each of the column lines and then monitor all the row lines to determine the coupling from the column line to each of the row lines. This provides a higher degree of accuracy in determining exactly which intersection of a particular row and column was touched. Each of the row lines is monitored to determine the value of signal coupled across the intersection with the column line being driven by the pulse or signal. Thus, if a pulse or any type of signal is generated on a particular column line, for example, it will be most strongly coupled across the intersection between that column line and a row line having a finger disposed across the particular intersection since this particular intersection will exhibit the highest change in mutual capacitance. In general, the capacitance across the intersection between row and column line will actually decrease when a finger is disposed in close proximity thereto. It should be understood that the pulse could be generated on row lines and the column lines sensed, as opposed to the illustrated embodiment wherein the pulse is generated on the column lines and then the row lines sensed. It is noted that for each generation of a pulse, the row lines are monitored at substantially the same time. This could be facilitated with dedicated analog-to-digital converters for each row/column line or a multiplexed bank of such. Such systems are disclosed in U.S. Patent Publication No. 2009-273570, entitled MULTI-TOUCH SENSOR PATTERNS AND STACK-UPS, filed Sep. 30, 2008 and U.S. Patent Publication No. 2009-0273579, entitled MULTI-TOUCH DETECTION, filed Apr. 30, 2009, both of which are incorporated herein by reference in their entireties.

Referring now to FIG. 1C, there is illustrated a more detailed block diagram of the scan control IC 102. At the heart of the scan control IC 102 is an 8051 central processing unit (CPU) 202. The scan control IC 102 is basically a microcontroller unit (MCU) which is described in detail in U.S. Pat. No. 7,171,542, issued Jan. 30, 2007 to the present assignee and entitled RECONFIGURABLE INTERFACE FOR COUPLING FUNCTIONAL INPUT/OUTPUT BLOCKS TO LIMITED NUMBER OF I/O PINS, which is incorporated herein by reference in its entirety. This is a conventional MCU that utilizes an 8051 core processor, flash ROM and various configurable ports that are configured with a cross bar switch. The CPU 202 interfaces with a special function register (SFR) bus 204 to allow interface between the CPU domain and that of the internal resources. The CPU 202 is powered with a digital voltage that is provided by a regulator 206 that receives power from an external V_{DD} source to power the digital circuitry on the chip. Analog power is provided at the V_{DD} level which has a wider range, as this can sometimes be supplied by a battery. The regulator 206 is controlled with a V_{DD} controller 210. A real time clock 212 is provided to allow the CPU to operate in a sleep mode with the clock 212 being activated. This is described in detail in U.S. Pat. No. 7,343,504, issued Mar. 11, 2008, entitled MICROCONTROLLER UNIT (MCU) WITH RTC, which is incorporated herein by reference in its entirety A RST/C2CK pin 214 provides a reset pulse and also provides the ability to communicate with the chip on a two-wire communication protocol with a clock and a data line. It provides a multi-function input of either the reset or the communication channel. This is interfaced with a power on reset block 216 for the reset mode. The CPU 202 has SRAM 220 associated therewith and the overall chip has associated therewith a block of flash ROM 222 to allow for storage of instructions and configuration information and the such to control the overall operation of the chip and provide the user with the flexibility of programming different functionalities therefor.

There are a plurality of resources that are associated with the chip, such as an I²C two-wire serial bus provided by a function block 224, timer functionality provided by block 226, a serial peripheral interface functionality provided by block 228, etc. These are described in detail in U.S. Pat. No. 7,171,542, which was incorporated herein by reference. There is provided a timing block 230 that provides the various clock functions that can be provided by internal oscillator, an external oscillator, etc. A boot oscillator 232 is provided for the boot operation and a PDA/WDT functionalities provided by block 234.

The SFR bus is interfaced through various internal resources to a plurality of output pins. Although not described in detail herein, a cross bar switch 236 determines the configuration of the I/O pins to basically “map” resources onto these pins. However, this cross bar functionality has been illustrated as a simple block that interfaces with a plurality of port I/O blocks 238 labeled port 0, port 1 . . . port N. Each of these port I/O blocks 238 interfaces with a plurality of associated output pins 240 and each is operable to selectively function as a digital input/output port such that a digital value can drive the output pin or a digital value can be received therefrom. Alternatively, each of the output pins can be configured to be an analog pin to output an analog voltage thereto or receive an analog voltage therefrom. Each of the ports is configured with a port I/O configuration block 242 that configures a particular port and a particular output therefrom as either a digital I/O or as an analog port. A GPIO expander block 244 controls the operation of each of the ports. All of the output pins are illustrated as being connected to an analog bus 248. The configuration of the analog bus 248 illustrates this as a common single line but in actuality, this is a bus of multiple lines such that each individual port can be selectively input to a particular multiplexer or a particular analog input/output function block, as will be described herein below.

The MTR block 114 is illustrated as having associated therewith two functionalities, one functionality is provided by an upper block 250 and this provides the pulse logic for generating a pulse. This requires a pulse generator 254 and pulse scanning logic 256. An analog multiplexer 258 selectively outputs the pulse from the pulse generator 254 to a selectively mapped port through the analog bus 248. The pulse scanning logic 256 determines which port is selected by the multiplexer 258. A lower functional block 259 of the MTR block 114 provides a plurality of analog-to-digital converters (ADC) 260, each for interface with an associated one of the MTR-CDC in designated pins that represents an input from one of the column lines or one of the row lines, depending upon which is the sensed side of the MTR function. Even though a plurality of dedicated ADCs 260 are provided, it should be understood that a lower number of ADCs could be utilized and the function thereof multiplexed.

The cap sense function is provided by the block 112 and this is comprised of an analog multiplexer 262 which is interfaced to a ADC 264 for selectively processing the selected column or row input received from the multiplexer 262. A scan logic block 266 provides the scanning control of the multiplexer 262. Thus, in one mode when the cap sense block 112 is utilized, the analog multiplexer 262 will select respective ones of the column and rows from the touch screen 104 for sensing the external capacitance thereon to determine if a change in the associated self capacitance has occurred. In a second mode, the MTR block 114 will be utilized to make a determination as to which of a row and column lines was actually touched in order to resolve any ambiguities when multiple touches on the screen occur. Further, as will be described herein below, it is possible to scan only a portion of the touch screen 104 in any one of the two modes. As will also be described herein below, the scan control IC 102 can be operated in conjunction with various power saving modes. These are referred to as “sleep” modes wherein the digital circuitry is essentially powered off and, at certain times, the chip is powered up and a scan completed. The scans can be a “fast” scan or a “slow” scan to vary the accuracy of the scan and, to further conserve power by reducing scan time, only a portion of the touch screen need be scanned, this portion defined by a determination in a fast scan mode that a certain portion of the touch screen indicates a touch which, thereafter, only requires a higher accuracy scan of that portion or, in an alternative embodiment, an application may only require that a certain portion of the touch screen be scanned. By limiting the area which is scanned, power can be conserved by only operating the digital section of the scan control IC 102 for that period of time, after which the digital section of the chip is placed back in a sleep mode of operation. The sleep mode of operation is described in U.S. Pat. No. 7,504,902, issued Mar. 3, 2009 and entitled PRECISION OSCILLATOR HAVING LINBUS CAPABILITIES, which is incorporated herein by reference in its entirety.

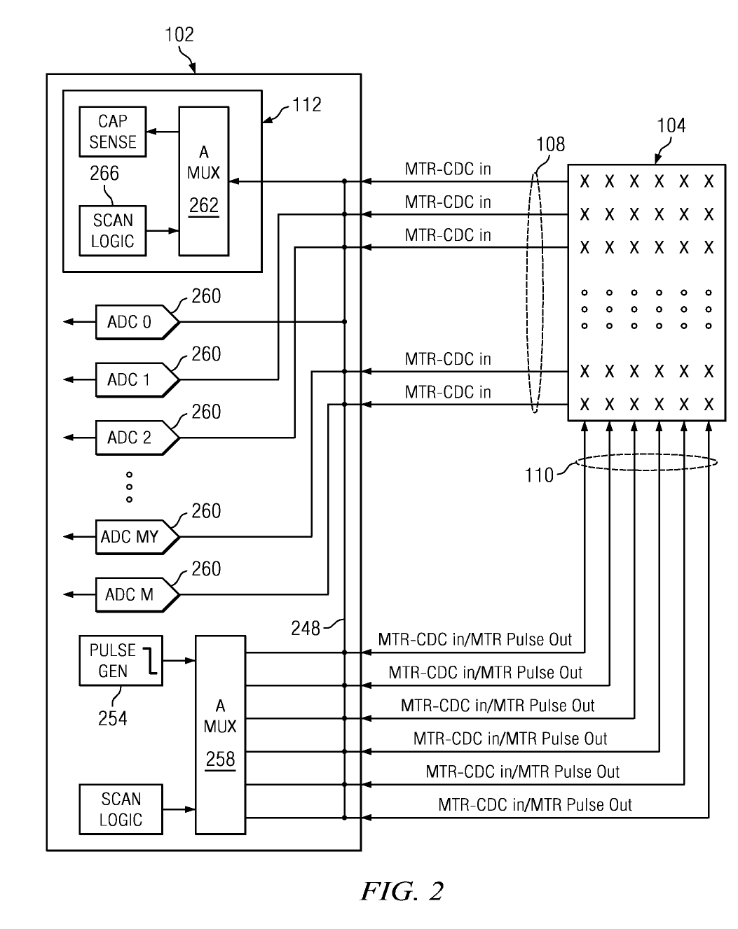

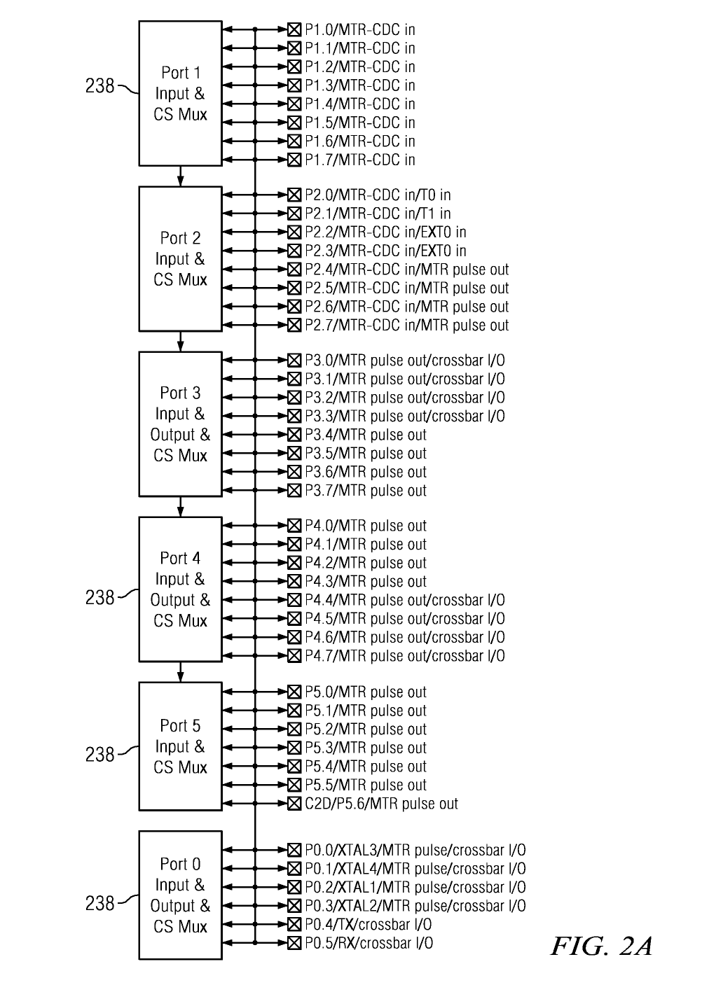

Referring now to FIG. 2, there is illustrated a diagrammatic view of the scan control chip 102 interfaced with the touch screen 104 showing only the analog interface between the scan control logic for cap sense and MTR modes of operation. It can be seen that there are a plurality of pins that are associated with either the row lines 108 or the column lines 110. The analog line 248 (which was noted as being an analog bus) is interfaced with the cap sense block 112 via the multiplexer 262 to select each of the row and column lines in any combination for sensing the self capacitance associated therewith, or with the output of each of the ADCs 260 associated with each of the MTR CDC in inputs (for the rows in this example) to sense the analog value thereof. Alternatively, each of the column lines 110 in this embodiment can be accessed with the pulse generator 254 in the MTR mode via the analog line (bus) 248. Therefore, there will be two modes of operation, one being for the MTR mode wherein a pulse or any kind of signal is generated on a particular columns (or rows) and then sensed on each of the row (or column) to determine the mutual capacitance therebetween and a second mode to determine the self capacitance of each of the row or column lines. Therefore, since each of the pins that can be associated with the touch screen 104 has the ability to function as an analog port to the chip, an analog signal can be output therefrom or received thereon and interfaced with the respective one of the capacitive sense block 112 or the MTR block 114.

Referring now to FIG. 2A, there is illustrated a detail of the port blocks 238 which illustrate the mapping thereto in one embodiment, this embodiment for scanning touch screens. There are illustrated six port blocks 238 which have the mapping defined typically by the cross bar switch and the analog connections. The cross bar is operable to define the digital interface between various functional blocks and the output pads 240. In this configuration, there are provided 16 MTR-CDC in pins and 31 MTR pulse out connections. This provides for essentially 31 rows and 16 columns, it being noted that the pulse can be input to either the rows or the columns with the sensing being done respectively, on either the columns or rows. All of the pulse out connections are able to be sensed by the cap sense functionality. Thus, the MTR-CDC in constitute the columns and the MTR pulse out connections provide the rows for the touch screen. It can be seen that the block 238 for port 1 services the MTR-CDC in exclusively whereas all of the pins associated with port 2 provide the same functionality. In addition, some of the port 2 output pins have a GPIO function, two of them being timer inputs and two of them being ext0 inputs. Four of the output pins associated with port 2 are associated with both the input and the pulse out functions of the MTR. For port 3, it can be seen that four pins are mapped to the cross bar I/O for a digital functionality as well as four of the pins on port 4. Substantially all of the pins associated with port 5 are associated with the MTR pulse outputs. A number of the port 0 outputs are associated with a crystal functionality and two are associated with the transmit/receive functionality for a serial port interface and various ones are associated with the cross bar inputs/outputs. It should be understood that the crossbar switch can be configured to map the outputs of multiple functional blocks within the IC 102 (internal resources) to the input/output pins and the various analog outputs/inputs of the pins can be interfaced with the two functional blocks 112 and 114 for sensing the capacitive value of the touch screen.

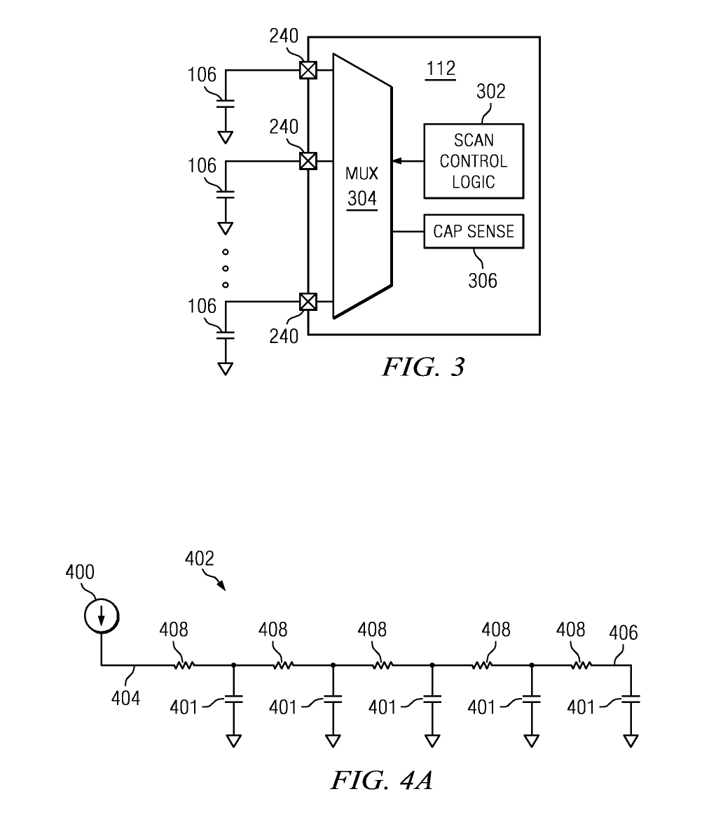

Referring to FIG. 3, there is illustrated one embodiment of a block diagram of the cap sense block 112 of FIG. 1. In the present example, the interface between the block 112 and the row lines or column lines (FIG. 1) are illustrated and these are referred to, for simplicity purposes, as “capacitive touch pads.” More specifically, the block 112 interfaces with the plurality of row or column lines (noted in the drawing as capacitive touch pads 106) that are each interfaced with the block 112 through respective external row lines 108 or column lines 110. The touch pads 106 are typically arranged in rows and columns and the illustrated touch pad 106 represents the self capacitance of one or a plurality of row lines or column lines. The capacitive touch pads 106 can be stand alone elements or they can be part of a capacitive sensor array, such as the touch screen 104 previously described. Although not illustrated, the block 112 also interfaces with columns on dedicated column pins (not shown).

The block 112 includes a multiplexer 304 that is operable to select one of the pins 240 and one plate of an associated capacitive touch pad 106 (or row line) for input to a capacitive sense block 306. The capacitive sense block 306 is operable to determine the value of the self capacitance for the row line (column line) associated with the selected pin 240. This will then allow a determination to be made as to the value of the self capacitance, which will be referred to as the capacitance associated with an “external capacitance switch,” (or row of switches) this value being the sum of the value of the associated capacitive touch pad(s) 106 attached to a given pin 240 and any parasitic capacitance such as may result from a finger touch, external interference, etc. (In actuality, all that is attached to a pin 240 is a row or column line but, as set forth hereinabove, a touch screen array of row and column lines that overlap will be referred to as an array of “switches.”) The information as to the self capacitance value of the external capacitance switch is then passed on to the MCU 113 for the purpose of determining changes in the capacitance value as compared to previous values, etc., with the use of executable instructions and methods. The multiplexer 304 is controlled by scan control logic 302 to sequentially scan the pins 240 from a beginning pin 240 and an end pin 240. This can be programmable through an SFR or it can be hardwired in combinational logic. One example of an application of such is described in previously incorporated U.S. patent application Ser. No. 12/146,349, filed on Jun. 25, 2008, entitled “LCD CONTROLLER CHIP.”

In general, one application would be to individually sense the static value of the self capacitance each of the row or column lines at each of the pins 240 at any given time and continually scan all or a portion of these row or column lines to determine if a change in self capacitance has occurred, i.e., whether the value of the self capacitance has changed by more than a certain delta. If so, with the use of a predetermined algorithm, a decision can be made as to whether this constitutes a finger touch or external interference. However, the capacitive sense block 112 is primarily operable to determine the self capacitance value of the row or column line connected to a pin 240 and then, possibly, provide some hardware control for accumulating the particular values and comparing them with prior values for generating an interrupt to the MCU 113. However, the first object of the capacitive sense block 112 is to determine the self capacitance value of the row or column line connected to a particular pin 240 being scanned at any particular time.

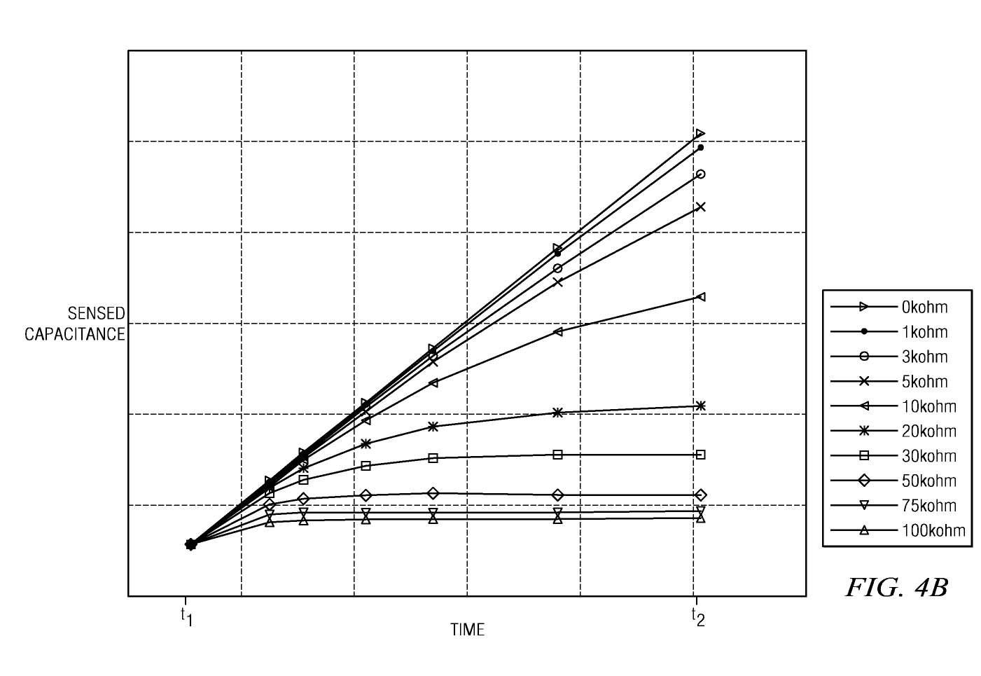

Referring to FIG. 4A, there is illustrated one embodiment of an idealized transmission line 402 coupled to a current source 400 via a row pin 204. The transmission line 402 represents a single column or row line such as may be part of, for example, a touch screen such as may be formed by the touch screen 104. The transmission line 402 may be viewed as a distributed capacitance comprised of a plurality of distributed capacitors 401 representing the row-to-ground capacitance or the column-to-ground capacitance by the capacitive sense block 306 of FIG. 3, with each of the distributed capacitors 401 contributing to the overall capacitance of the transmission line. For purposes of example, the transmission line 402 is shown with the distributed capacitors 401 extending from a near end 404 of the transmission line 402 to a far end (or terminal end) 406 and referred to ground. As illustrated, this places the distributed capacitors 401 so that some of the distributed capacitors 401 are located closer to the near end 404 and others are located closer to the far end 406. This illustrates the distributed capacitance along the column/row line. The transmission line 402 also consists of a distributed resistance represented by resistors 408 disposed thereon distributed capacitors 401. It is understood that the transmission line 402 may be formed in many different ways and that FIG. 4A is provided only for purposes of illustration.

In the present example, the transmission line 402 is a metallic strip formed of a semi-transparent conductor made of indium tin oxide (InSnO) or another suitable material. As is known, InSnO is conductive but highly resistive and the transmission line 402 may have a distributed resistance in the range of one to one hundred kilohms (1-100 k ohms). In touch screens, the metallic strip forming the transmission line 402 is typically relatively wide, which will typically increase the capacitance and reduce the sheet resistance. The distributed resistance and capacitance of the transmission line 402 provide the line with a high time constant and create an RC filter that prevents changes in the distributed capacitors 401 near the terminal end 406 from being fully sensed by the capacitive sense block 306 that is coupled to the near end 404. Not only do the distributed capacitors 401 at the terminal end 406 take longer to charge, but the distributed resistance in the transmission line 402 between the far end distributed capacitors 401 and the near end attenuates the impact of those distributed capacitors 401 on the capacitance sensed by the capacitive sense block 306. In other words, the farther a distributed capacitor 401 is located from the near end 404, the more attenuated its input to the overall capacitance of the transmission line 402 as sensed by the capacitive sense block 306. This also means that the distributed capacitor 401 at the far end 406 defines the resolution of the transmission line 402, as its input is the smallest input into the total capacitance.

Referring to FIG. 4B, there is illustrated a graphical representation 410 of sensed capacitance (y-axis) over charge time (x-axis) for varying levels of resistance from zero to one hundred kilohms (1-100 kΩ) over the transmission line 402 of FIG. 4A. As can be seen in FIG. 4B, with a resistance of zero kilohms, the capacitance change in the distributed capacitor 401 between times t₁ and t₂ is substantially linear and represents a relatively large increase in capacitance. This change can be easily sensed and means that the corresponding distributed capacitor 401 has a large contribution to the overall capacitance measurement of the transmission line 402 as sensed by the capacitive sense block 306. This also means that the distributed capacitor 401 can be sensed quickly, as relatively small levels of change in capacitance can be detected due to the rapid increase in capacitance caused by even a relatively small change. For purposes of illustration, the distributed capacitor 401 having the lowest resistance in a series therewith will likely be at the near end 404 of the transmission line 402.

However, as the amount of series resistance (and therefore attenuation) increases, it becomes more difficult to detect capacitance changes in a distal portion of a row/column line and more time is needed to allow the most distal distributed capacitor 401 to fully charge in order for the voltage thereacross to be reflected in the voltage at the near end in order to detect the change in capacitance on that capacitor. For example, in the worst case of one hundred kilohms, and a fast ramp rate where the far end distributed capacitor has not been allowed sufficient time to charge, the change in capacitance that is sensed by the capacitive sense block 306 is small (relative to the case of zero resistance) since the voltage contribution of the most distal distributed capacitor 401 to the overall voltage at the near end 404 is minor.

By way of further explanation of the attenuation concept, the current source 400 is controlled to charge the column or row line for a predetermined amount of time. For quick sensing, this time is shortened and for higher resolution sensing, this time is lengthened. Typically, as will be described herein below, the current is varied to drive the transmission line until the voltage reaches a predetermined threshold. The time for reaching this threshold is a set time and the current in current source 400 is adjusted such that the voltage on the top of the transmission line, i.e., at pin 240, will ramp-up and reach the threshold voltage at a fixed time. Therefore, for quick sensing, the time period for this quick sensing and the short time period, what will happen is that the RC time constant for each distributed capacitor 401 will be such that the distributed capacitor 401 is not fully charged, i.e., there will be voltage across the resistance in series with the current source 400. This current is flowing through all the resistors, with the distributed capacitor 401 at the terminal end 406 having the larger series resistance and, hence, the voltage across the series resistance of all of the resistors 408 will be higher. For example, if the time period were such that the distributed capacitor 401 at the near end charged up only to 80% of its value at the end of the fixed time period, any change in the capacitance thereof would only result in an 80% change in the voltage at the top end of the transmission line, i.e., any change in the capacitance value of the first capacitance would result in the voltage across the distributed capacitor 401 and the voltage at the top end being attenuated by 20%. Consider then that the voltage across the distributed capacitor 401 at the terminal end is only 10% of the value at the top end of the transmission line. This means that any change in the capacitance of a distributed capacitor 401 at the terminal end would be 90% attenuated relative to the voltage level at the top of the transmission line. Therefore, a 10% change in the distributed capacitor 401 at the tail end compared to that at the near end would be different. Thus, to have an accurate measurement of the capacitance and any change thereto, it would be desirable to allow all the distributed capacitors 401 to fully charge before making a determination as to the value thereof. Thus, by examining the voltage at the top end of the transmission line, small changes in the capacitance value of the distributed capacitor 401 at the tail end will be difficult to detect when the rate of the ramp is fast and full charging is not possible dur to the distributed series resistance, but gross changes can be detectible. Once a gross change is detected, then the fixed time can be reset for the ramp rate such that the current source 400 operates for a longer period of time allowing all the distributed capacitors 401 to more fully charge.

Accordingly, there is a tradeoff between sensing speed and sensing resolution when considering how rapidly to sense the capacitance value of the distributed capacitor 401 provided by the transmission line 402. Sensing the capacitance value at a high enough resolution to detect changes in the far end distributed capacitor 401 needs each of the distributed capacitors 401 along the transmission line 402 to be more fully charged, which requires enough time for the distributed capacitor 401 at the far end 406 to fully charge. However, sensing at an increased speed needs the charging times to be as short as possible in order to scan the columns and rows quickly, which means that some of the distributed capacitors 401 may not have time to fully charge. It may be difficult to sense changes in capacitance if some of the distributed capacitors 401 do not fully charge, particularly when their input is already attenuated due to resistance in the transmission line 402. Therefore, it may be desirable to be able to control the charge time of such distributed capacitors 401 in order to achieve a balance between sensing speed and resolution. This balance may be further adjusted in response to sensed input, with changes in sensing speed and accuracy being made to adapt to input in real time. For purposes of convenience, the present disclosure may refer to either sensing speed and sensing resolution or may refer to sensing speed/resolution and it is understood that they are simply ways to view the same balance issue from different sides. For example, a user interested in sensing resolution may select a speed that provides that resolution in the same manner that the user may select the resolution itself.

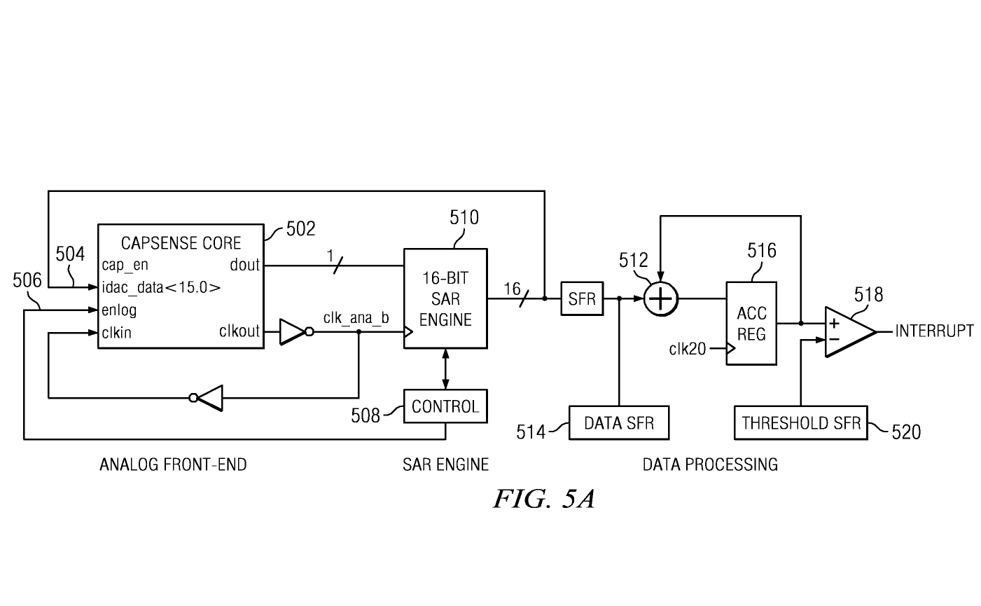

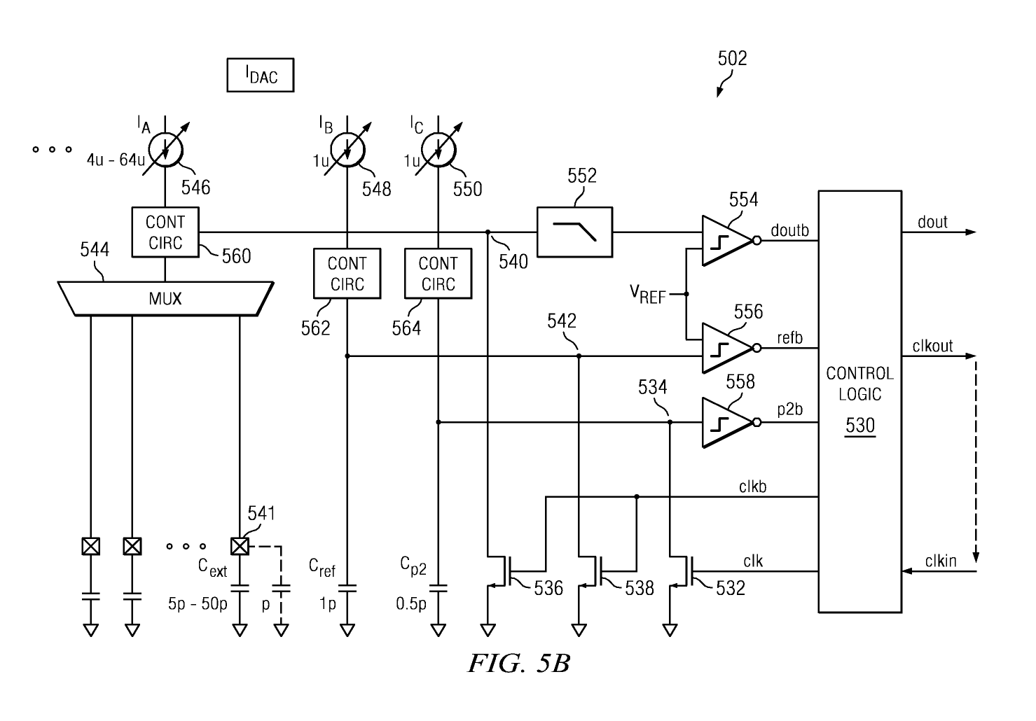

Referring now to FIGS. 5A and 5B, one embodiment of a functional block diagram of the capacitive touch sense block 306 is illustrated. The analog front end circuitry 502 shown in FIG. 5A is responsible for a connected external capacitance switch (a row or column line) for the purpose of determining the value of the self capacitance thereof. The analog front end circuitry 502 receives a 16-bit current control value which is provided to the input IDAC_DATA via input 504 for controlling a variable current source. This current is generated by a current digital-to-analog converter (IDAC), not shown. The analog front end also receives an enable signal at the input ENLOG 506 from a control circuit 508. The analog front end circuitry 502 additionally provides a clock signal. A 16-bit successive approximation register (SAR) engine 510 controls a first variable current source within the analog front end circuitry 502 that drives the external capacitance switch. The 16-bit SAR engine 510 changes a control value which defines a present value of a variable current I_{A} that drives an external capacitor C_{EXT} (as seen in FIG. 5B) on a selected one of the output pads 541. This selection is made by multiplexer 544, and the capacitor C_{EXT} corresponds to self capacitance of the respective row or column line in combination with any parasitic capacitance of the row or column line. The current source generating the current I_{A} that drives the selected external capacitor C_{EXT} from current source 546 will cause a voltage to be generated on that external capacitor C_{EXT} that is compared to the voltage across an internal reference capacitor C_{REF} (as shown in FIG. 5B). This capacitor C_{REF} is an internal capacitor and the current provided thereto from an internal current source is a constant current for a given capacitance measurement. The currents I_{A} and I_{B} may be further configurable via respective current control circuitry 560 and 562 to vary the current (seen in FIG. 5B), as will be described below.

Both capacitors, the selected capacitor C_{EXT} and the reference capacitor C_{REF}, are initialized at a predetermined point and the currents driven thereto allow the voltages on the capacitors C_{EXT} and C_{REF} to ramp-up at the rate determined by the respective capacitance value and the current provided by the respective current sources and current control circuitry that provide driving current thereto. By comparing the ramp voltages and the ramp rates, a relative value of the two currents can be determined. This is facilitated by setting a digital value to the IDAC and determining if the ramp rates are substantially equal. If the capacitors C_{EXT} and C_{REF} were identical, then the two ramp rates would be substantially identical when the current driving capacitors C_{EXT} and C_{REF} are substantially identical. If the capacitor C_{EXT} is larger, this would require more current to derive a ramp rate that is substantially identical to the capacitor C_{REF}. Once the SAR algorithm is complete, the 16-bit value “represents” the capacitance value of the external capacitor on the external node, i.e., the self capacitance of the row or column line.

The current source control value for variable current source 546 is also provided to an adder block 512. The control value establishing the necessary controlled current is stored within a data Special Function Register (SFR) 514 representing the capacitive value of the external capacitance switch. This SFR 514 is a register that allows for a data interface to the CPU 202. Second, an input may be provided to an accumulation register 516 for the purpose of determining that a touch has been sensed on the presently monitored external capacitor switch of the touch screen. Multiple accumulations are used to confirm a touch of the switch, depending upon the particular algorithm utilized. The output of the accumulation register 516 is applied to the positive input of a comparator 518 which compares the provided value with a value from a threshold SFR register 520. When a selected number of repeated detections of activations, i.e., changes, of the associated self capacitance for a given row/column line have been detected, the comparator 518 generates an interrupt to the CPU 202. The output of the accumulation register 516 is also provided to the adder block 512.

Referring now specifically to FIG. 5B, there is illustrated a more detailed diagram of the analog front end circuitry 502. The analog front end circuitry 502 includes control logic 530 that provides an output dₒᵤₜ that is provided to the successive approximation register engine 510 and the output clock “clk_out.” dₒᵤₜ indicates a condition indicating that the ramp voltage on C_{EXT} was faster than the ramp voltage across C_{REF}, this indicating that the SAR bit being tested needs to be reset to “zero.” The logic 530 receives an input clock signal “clkn” and provides an output clock signal “clk” and an output clock signal “clkb” (clock bar) to a series of transistors.

The output “clk” is provided to a first n-channel transistor 532. The drain/source path of transistor 532 is connected between node 534 and ground. The gate of transistor 532 is connected to receive the “clk” signal. The gates of transistors 536 and 538 are connected to the clock bar signal “clkb.” The drain/source path of transistor 536 is connected between node 540 and ground, node 540 being connected to an output pad 541 (similar to pin 240) via multiplexer 544. The drain/source path of transistor 538 is connected between node 542 and ground.

The transistors 536, 538 and 532 act as discharge switches for capacitors C_{EXT}, C_{REF} and C_{P2}, respectively. Capacitor C_{EXT} is coupled between the associated output of multiplexer 544 and ground. Capacitor C_{REF} is connected between internal node 542 and ground. Capacitor C_{P2} is connected between internal node 534 and ground. The capacitor C_{EXT} represents the self capacitance of the selected capacitor touch pad 106 of the touch screen 104 and is variable in value, this C_{EXT} representing the self capacitance of a given row or column line. For example, the capacitive value thereof can change based upon whether the associated capacitor touch pad 106 is being actuated by the finger of the user or not. The multiplexer 544 or other switching circuitry is utilized to connect other external capacitance switches (row or column lines) within the touch screen 104 to node 540 to determine their self capacitance values.

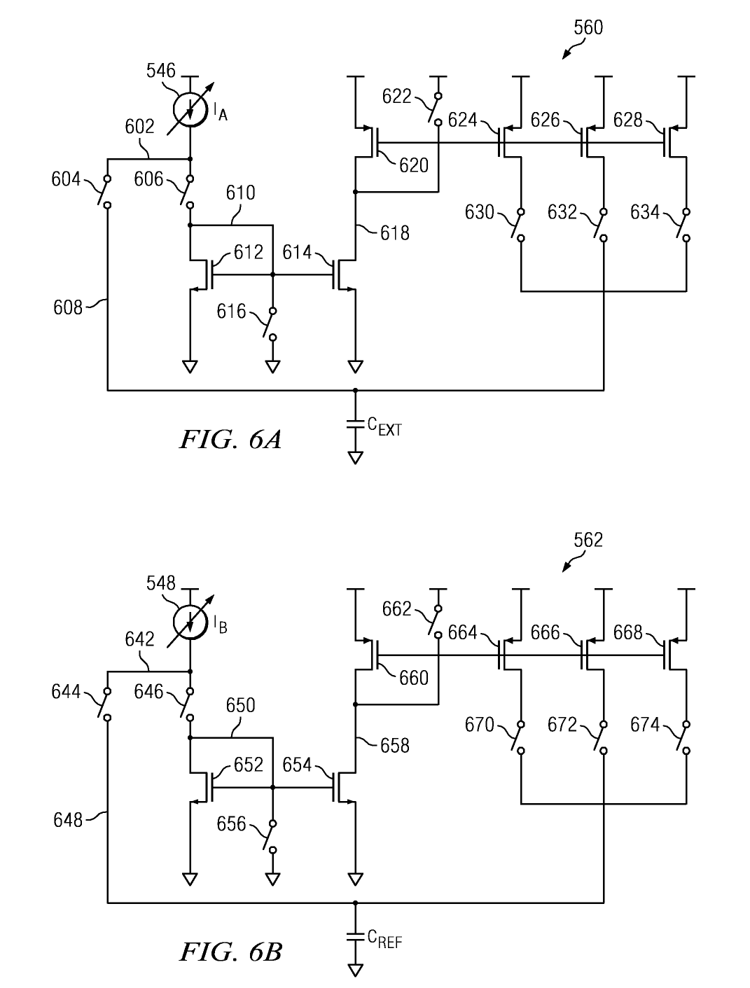

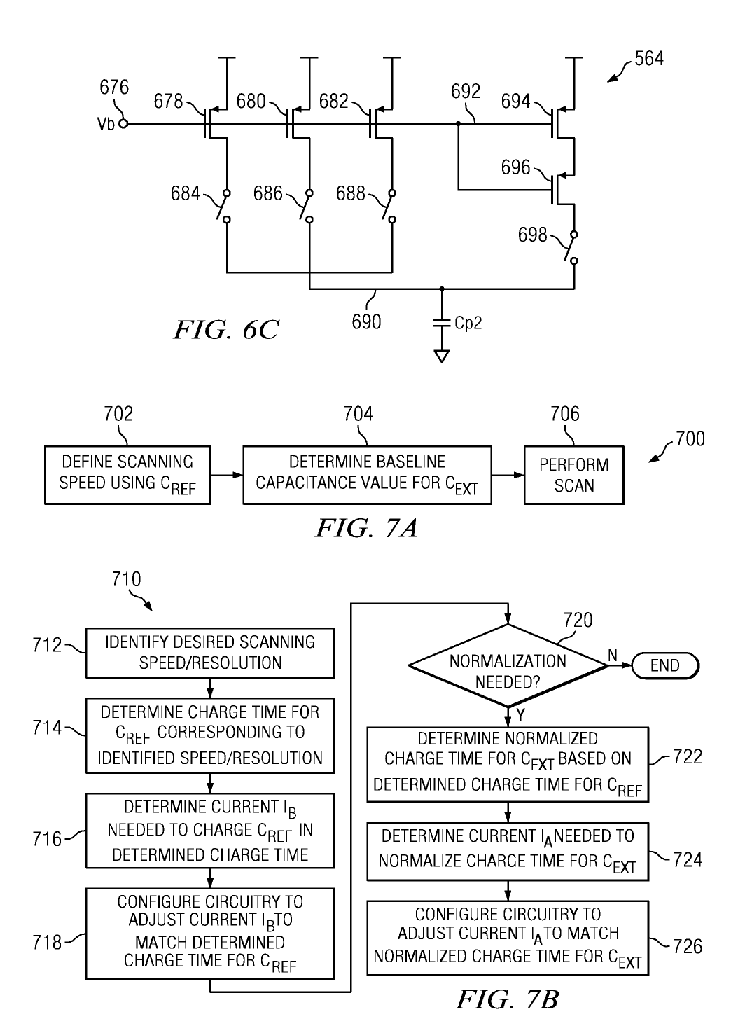

The variable current source 546 provides a current input to node 540. The variable current source 546 (an IDAC) is under the control of a 16-bit data control value that is provided from the successive approximation register engine 510. The current source 546 is used for charging the capacitor C_{EXT} when transistor 536 is off, this providing a “ramp” voltage since current source 546 provides a constant current I_{A}. The current I_{A} is further programmable via current control circuitry 560 (described in greater detail below with respect to FIG. 6A) that enables the current I_{A} to be modified in order to change the nominal charge time of the capacitor C_{EXT}, i.e., a coarse adjustment. When transistor 536 is conducting, the charging current and the voltage on capacitor C_{EXT} are shorted to ground, thus discharging C_{EXT}.

The current source 548 provides a constant charging current I_{B} into node 542. This charging current provides a charging source for capacitor C_{REF} when transistor 538 is off to generate a “ramp” voltage, and the current I_{B} is sunk to ground when transistor 538 is conducting, thus discharging capacitor C_{REF}. The current I_{B} is variable to provide a fine adjustment and programmable via current control circuitry 562 (described in greater detail below with respect to FIG. 6B) to provide a coarse adjustment that enables the current I_{B} to be modified in order to change the charge time of the capacitor C_{REF}, i.e., a coarse adjustment during a capacitance value determining step.

Likewise, current source 550 provides a constant charging current I_{C} to node 534. This current source 550 is used for charging capacitor Cₚ₂ to generate a “ramp” voltage when transistor 532 is off, and I_{C} is sunk to ground when transistor 532 is conducting, thus discharging capacitor C_{P2}. The current I_{C} may be variable to provide a fine adjustment and programmable via current control circuitry 564 (described in greater detail below with respect to FIG. 6C) to provide a coarse adjustment that enables the current I_{C} to be modified in order to change the discharge time of the capacitor C_{P2}.

Connected to node 540 is a low pass filter 552. The low pass filter 552 is used for filtering out high frequency interference created at the self capacitance (C_{EXT}) of the given row/column line in the touch screen 104. The output of the low pass filter 552 is connected to the input of a comparator 554. The comparator 554 compares the ramp voltage at node 540 representing the charging voltage on capacitor C_{EXT} to a threshold reference voltage V_{REF} (not shown) and generates a negative pulse when the ramp voltage at node 540 crosses the reference voltage V_{REF}. This is provided to the control logic 530 as signal “doutb.” Similarly, a comparator 556 compares the ramp voltage of the fixed capacitance C_{REF} at node 542 with the threshold reference voltage V_{REF} and generates an output negative pulse “refb” when the voltage at node 542 crosses the threshold reference voltage V_{REF}. Finally, the comparator 558 compares the ramp voltage at node 534 comprising the charge voltage on capacitor C_{P2} with the threshold reference voltage V_{REF} and generates an output responsive thereto as signal “p2b” when the ramp voltage at node 534 exceeds the threshold reference voltage.

In basic operation, the circuit in FIG. 5B operates by initially resetting the voltage on capacitors C_{EXT} and C_{REF} to zero by turning on transistors 536 and 538. This causes the voltage on capacitors C_{EXT} and C_{REF} to discharge to ground. The transistors 536 and 538 are then turned off, and the voltage on capacitors C_{EXT} and C_{REF} begins to ramp up toward the reference voltage V_{REF} responsive to the current output of the respective current sources 546 and 548. If the voltage across capacitor C_{EXT} reaches the threshold voltage V_{REF} prior to the voltage across capacitor C_{REF} reaching the threshold voltage, this trips the output of comparator 554 to provide a negative pulse and this information is provided from the control logic 530 as output dₒᵤₜ to the successive approximation register engine 510 to allow the SAR bit being tested to remain a “one,” and a next value of the 16-bit control value for the current source 546 will be selected for testing when CREF crosses the threshold reference voltage level V_{REF}. Since the comparator 554 “tripped” before comparator 556, this indicates less current is needed for the next bit tested.

The control logic 530 generates the dₒᵤₜ signal controlling the operation of setting bits of the 16-bit SAR control value by the successive approximation register engine 510 responsive to the output from comparator 554. The successive approximation register engine 510 initially sets a most significant bit of the 16-bit control value to “one” and the rest to “zero” to control the variable current source 546 to operate at one-half value. If the output of comparator 554 goes low prior to the output of comparator 556 going low, the dₒᵤₜ signal provides an indication to the successive approximation register engine 510 to reset this bit to “zero” and set the next most significant bit to “one” for a next test of the 16-bit SAR control value. However, when the output of comparator 556 goes low prior to the output of comparator 554 going low, the bit being tested remains set to “one” and a next most significant bit is then tested. This process continues through each of the 16-bits of the 16-bit control value by the successive approximation register 510 engine responsive to the signal dₒᵤₜ from the control logic 530 until the final value of the 16-bit control value to the variable current source 546 is determined.

The “clkb” output resets the voltages across C_{EXT} and C_{REF} by turning on transistors 536 and 538 to discharge the voltages on these capacitors, and the transistors 536 and 538 are turned off to enable recharging of capacitors C_{EXT} and C_{REF} using the provided respective variable current and the respective reference current, respectively. The voltages across the capacitors C_{EXT} and C_{REF} are again compared by comparators 554 and 556 to the threshold reference voltage V_{REF}. When the output of comparator 556 provides a negative output pulse prior to the output of comparator 554 this provides an indication to set an associated bit in the 16-bit control value to “one” as described above. The 16-bit control value that is being provided to the variable current source 546 will be stored when the SAR algorithm is complete at which point both voltages ramp-up at substantially the same rate. The current I_{A} being provided by the variable current source 546 that is associated with the established 16-bit value, the fixed current I_{B} of current source 548 and the fixed capacitance value C_{REF} may be used to determine the value of the capacitance C_{EXT} according to the equation I_{A}/I_{B}×C_{REF} using associated processing circuitry of the array controller. Even though the actual value of C_{EXT} could be determined with this equation, this is not necessary in order to determine that the self capacitance value of the given row or column line has changed. For capacitive touch sensing, it is only necessary to determine a “delta” between a prior known self capacitance value of the given row or column line and a present value thereof. Thus, by repeatedly scanning all of the external capacitance switches in the capacitive sensor array and comparing a present value therefor with the prior value therefor, a determination can be made as to whether there is a change. Thus, it is only necessary to have a “normalized” value stored and then compare this pre-stored normalized value with a new normalized value. The actual value is not important but only the delta value is important.

By using similar circuitry to generate the ramp voltages and to compare the voltages at nodes 540 and 542, substantially all common mode errors within the circuitry are rejected. Only the filter 552 upsets the common mode balance between the circuits, but this is necessary to prevent high frequency interference from outside sources such as cell phones. The circuitry for measuring the voltages at the nodes provides a proportional balance between the internal reference voltage and the external capacitance voltage. Thus, errors within the comparators or the reference voltage V_{REF} are not critical as they are the same in each circuit. It is noted that, for a given capacitance value determination slip, C_{EXT} and the value of I_{B} are constant, thus setting the maximum time for charging, i.e., the resolution.

The circuitry and functionality described herein with respect to FIGS. 5A and 5B are further detailed in previously incorporated U.S. patent application Ser. No. 12/494,417, filed on Jun. 30, 2009, entitled SYSTEM AND METHOD FOR DETERMINING CAPACITANCE VALUE.

Referring to FIG. 6A, one embodiment of the current control circuitry 560 of FIG. 5B is illustrated in greater detail. The circuitry 560 provides the ability to control the coarse amount of current I_{A} that is provided to the capacitor C_{EXT} beyond the level of control provided by the current source 546 as described previously. Use of the current control circuitry 560 will be described in conjunction with use of the current control circuitry 562 later with respect to FIG. 7A.

The circuitry 560 is positioned to mirror the current source 546 for I_{A} to the capacitor C_{EXT}. The circuitry 560 includes a node 602 coupled to switches 604 and 606. The switch 604 is directly coupled to the capacitor C_{EXT} via a node 608. The switch 606 is coupled to a node 610 that is in turn coupled to the gates of transistors 612 and 614 that form a current mirror. The source of the transistor 612 is coupled to ground and the drain is coupled to the node 610. The source of the transistor 614 is coupled to ground and the drain is coupled to a node 618. The node 610 is also coupled to ground via a switch 616 that may be actuated to ground the gates of the transistors 612 and 614.

The current mirror is coupled via the node 618 to the drain of a P-channel transistor 620. The node 618 is also coupled to switch 622 that may be actuated to couple the node 618 to the gate of the transistor 620. The gate of the transistor 620 is coupled to the gates of parallel connected P-channel transistors 624, 626, and 628 that, in the present example, are P-channel transistors arranged in a binary weighted manner to provide selectable current values based on input from the SFR 514. Switches 630, 632, and 634 couple the transistors 624, 626, and 628, respectively, to the capacitor C_{EXT} via the node 608 and are controlled by bits from the SFR.

In operation, the switches 630, 632, and 634 may be actuated by control logic 530, control bits from the SFR 514, or another part of the capacitive touch sense circuitry 502. Control bits from the SFR are used to actuate the switches 630, 632, and 634 and therefore add or remove them from the current path in order to modify the coarse value of the current I_{A} that reaches the capacitor C_{EXT} from the current source 546 with the fine adjustment facilitated with the I_{DAC}. In the present embodiment, the current may be provided at ratios as illustrated below in Table 1:

TABLE 1

| Control bits | N (ratio of splitter) |
|---|---|
| 000 (default) | 1 |
| 001 | 8/1 = 8 |
| 010 | 8/2 = 4 |
| 011 | 8/3 = 2.67 |
| 100 | 8/4 = 2 |
| 101 | 8/5 = 1.6 |
| 110 | 8/6 = 1.33 |
| 111 | 8/7 = 1.14 |

Referring to FIG. 6B, one embodiment of the current control circuitry 562 of FIG. 5B is illustrated in greater detail. The circuitry 562 provides the ability to control the coarse amount of current I_{B} that is provided to the capacitor C_{REF} thereby enabling the charge time of the capacitor C_{REF} to be altered (e.g., sped up or slowed down) with fine adjustment provided by an I_{DAC} that generates the I_{B} current. The control circuitry 640 may be part of the current source 548 or may be external to the current source. Use of the current control circuitry 562 will be described in conjunction with use of the current control circuitry 560 later with respect to FIG. 7A.

The circuitry 562 mirrors the current source 548 for I_{B} to the capacitor C_{REF}. The circuitry 562 includes a node 642 coupled to switches 644 and 646. The switch 644 is directly coupled to the capacitor C_{REF} via a node 648. The switch 646 is coupled to a node 650 that is in turn coupled to the gates of transistors 652 and 654 that form a current mirror. The source of the transistor 652 is coupled to ground and the drain is coupled to the node 650. The source of the transistor 654 is coupled to ground and the drain is coupled to a node 658. The node 650 is also coupled to ground via a switch 616 that may be actuated to ground the gates of the transistors 652 and 654.

The current mirror is coupled via the node 658 to the drain of a P-channel transistor 660. The node 658 is also coupled to switch 662 that may be actuated to couple the node 658 to the gate of the transistor 660. The gate of the transistor 660 is coupled to the gates of parallel connected P-channel transistors 664, 666, and 668 that, in the present example, are arranged in a binary weighted manner to provide selectable current values based on input from the SFR 514. Switches 670, 672, and 674 couple the transistors 664, 666, and 668, respectively, to the capacitor C_{REF} via the node 648 and are controlled by bits from the SFR.

In operation, the switches 670, 672, and 674 may be actuated by control logic 530, control bits from the SFR 514, or another part of the capacitive touch sense circuitry 502. Control bits from the SFR are used to actuate the switches 670, 672, and 674 and therefore add or remove them from the current path in order to modify the coarse value of the current I_{B} that reaches the capacitor C_{REF} from the current source 548 with the fine adjustment facilitated with an I_{DAC}. In the present embodiment, the current may be provided at ratios as illustrated previously with respect to Table 1.

It is understood that different current control circuitry may be needed for each of the capacitors C_{REF} and C_{EXT} due to differences in the minimum and maximum current levels provided to each capacitor by the current sources 548 and 546, respectively. For example, the current source 546 may provide I_{A} in the range of 4 μA-75 μA, while the current source 548 may provide I_{B} in the range of 0.125 μA-1 μA.

Referring to FIG. 6C, one embodiment of the current control circuitry 564 of FIG. 5B is illustrated in greater detail. The circuitry 564 provides the ability to control the amount of current I_{C} that is provided to the capacitor Cₚ₂ thereby enabling the discharge time of the capacitor C_{REF} to be altered.

The circuitry 564 is positioned between the current source 550 for I_{C} and the capacitor C_{P2}. As illustrated, the circuitry 564 includes a node 676 coupling V_{b} to the gate of a transistor 678. The transistor 678 forms a binary weighted transistor set in conjunction with transistors 680 and 682. The drains of the transistors 678, 680, and 682 are coupled with switches 684, 686, and 688, respectively that may be actuated to couple and decouple their corresponding transistor to a node 690 that is further coupled to the capacitor C_{P2}. The transistor gang is coupled to the gates of transistors 694 and 696 via node 692. The drain of the transistor 696 is coupled to node 690 via a switch 698.

In operation, the current control circuitry 564 may be configured to vary the current provided to the capacitor C_{P2}. As with the current control circuitry 560 and 562, the current control circuitry 564 may provide current to its corresponding capacitor C_{P2} based on ratios provided by the transistor set, which may be similar to those provided previously in Table 1. Accordingly, using the current control circuitry, the discharge time of the capacitor C_{P2} may be altered.

Referring to FIG. 7A, one embodiment is illustrated of a flow chart depicting a method 700 by which the overall scanning process may be accomplished. In step 702, the scan speed may be defined by modifying the charging time of the capacitor C_{REF} and modifying the coarse value of current I_{A} that drives C_{EXT}. This process will be described below in greater detail. In step 704, a baseline capacitance value may be determined for C_{EXT} as described above and also described in detail in previously incorporated U.S. patent application Ser. No. 12/494,417, filed on Jun. 30, 2009, entitled SYSTEM AND METHOD FOR DETERMINING CAPACITANCE VALUE. In step 706, the scan may be performed as described above and also described in detail in previously incorporated U.S. patent application Ser. No. 12/146,349, filed on Jun. 25, 2008, entitled LCD CONTROLLER CHIP.

Referring to FIG. 7B, one embodiment is illustrated of a flow chart depicting a method 710 by which the charging time of the capacitor C_{REF} of FIG. 5B may be modified to alter the sensing speed with which the capacitive sense block 306 can sense capacitance changes in the touch screen 104. In step 712, a desired sensing speed/resolution is identified for the scanning process. For example, an application designer for a particular application that uses the touch screen 104 may not care about sensing information other than information indicating that a row has been touched. In this case, the designer may configure the circuitry 650 to provide more current to the capacitor C_{REF} in order to shorten the charge time of the capacitor up to the threshold voltage V_{REF}. Due to this additional current, the capacitor C_{REF} will hit the threshold more quickly while establishing the baseline capacitance value for C_{EXT} as described previously, which in turn speeds up the race between the voltage on the capacitors C_{REF} and C_{EXT}. In order to match the voltage ramps on the capacitors C_{REF} and C_{EXT}, the capacitive sense block 306 will increase the current provided to the capacitor C_{EXT} via the current source I_{A}, making the capacitor C_{EXT} also charge more quickly. Because of the more rapid charging, distributed capacitors 401 at the far end 406 of the transmission line 402 may not have time to fully charge. Accordingly, the row and column lines in the touch screen 104 will be scanned more quickly, but the scanning may not detect relatively small changes in capacitance.

Alternatively, the application designer may care more about sensing at a higher resolution than about speed. In this case, the designer may configure the circuitry 650 to provide less current to the capacitor C_{REF} in order to lengthen the charge time of the capacitor to the threshold voltage V_{REF}. In turn, the voltage across capacitor C_{REF} will read the threshold more slowly, which slows down the race between the voltage ramp on the capacitors C_{REF} and C_{EXT}. In order to match the voltage ramp on the capacitors C_{REF} and C_{EXT}, the capacitive sense block 306 will decrease the coarse level of the current provided to the capacitor C_{EXT} via the current source I_{A}, making the capacitor C_{EXT} also charge more slowly. Because of the slower charging, distributed capacitors 401 at the far end 406 of the transmission line 402 will have time to more fully charge, assuming the charge time is sufficiently long. Accordingly, the row and column lines will be scanned more slowly, but the scanning will detect relatively small changes in capacitance.

It is understood that the identified speed/resolution may be selected as desired (e.g., the designer may enter a desired value or a set of parameters that are not limited other than by minimum and maximum values of the system itself) or the speed/resolution may be selected from a predefined set of values that correspond to system resolutions available to the designer.

In step 714, a charge time for the capacitor C_{REF} is determined that corresponds to the speed/resolution identified in step 712. The charge time may be obtained in many different ways. For example, the charge time may selected from one of a plurality of predefined charge times stored in a table in memory that is indexed by speed/resolution or the charge time may be calculated in real time based on the known value of the capacitor C_{REF}.

In step 716, a determination is made as to an amount of current I_{B} needed to charge the capacitor C_{REF} in the charge time determined in step 714, i.e., the maximum time to reach the threshold voltage V_{REF}. It is understood that the determination of the amount of current I_{B} may not only ensure that the capacitor C_{REF} is charged in that period, but that the capacitor C_{REF} reaches its full charge as close to that time as possible (i.e., within the constraints of the controlling circuitry). Accordingly, if the current I_{B} can be provided at particular defined levels as described previously (e.g., as controlled by three MSB bits used to manipulate binary weighted transistors and the remaining LSBs defining the current source 548 value), then the closest level will be selected, but the current may not exactly match the desired charge time (defined as the time for C_{REF} to charge to V_{REF}). In some embodiments, only charge times that correspond to possible current values may be available for use. The current I_{B} may be obtained in many different ways. For example, the current I_{B} may selected from one of a plurality of predefined currents stored in a table in memory that is indexed by charge times or the current may be calculated in real time based on the desired charge time.

In step 718, circuitry may be configured to provide the level of current I_{B} determined in step 716 to the capacitor C_{REF}. For example, the current control circuitry 650 may be used to adjust the current level. It is understood that the current I_{B} may be controlled in many different ways, including direct current manipulation (e.g., if the current I_{B} is directly controllable) or by using many different types of circuits. The method 710 is directed to manipulating the current I_{B} in order to change the charge time of the capacitor C_{REF} and is not concerned with how the current is manipulated.

In step 720, a determination may be made as to whether the charge time of the capacitor C_{EXT} needs to be normalized. More specifically, the charge time of the capacitor C_{REF} may be modified in step 718 so as to make it difficult or impossible to establish a valid race condition with the capacitor C_{EXT}. For example, assume that the capacitor C_{EXT} must charge within a particular window of time in order for a race condition with the capacitor C_{REF} to be valid. This window may be based on minimum and maximum levels of current available to the capacitor C_{EXT} or on other parameters. If the charge time for C_{REF} is shifted too far in step 718 relative to the window for C_{EXT}, then C_{EXT} may have a very limited amount of room (or no room) within which its charge time can be changed to find the best match during the comparisons. For example, if the charge time for C_{REF} is increased until it is outside of or on the upper edge of the window for C_{EXT}, then C_{EXT} may be unable to increase its charge time enough to provide a match for the respective ramp voltages during a comparison. In such a case, it is desirable to shift the charging window for C_{EXT} back into line (or at least more in line) with the charge time for C_{REF}, which is referred to herein as normalizing the charge time for C_{EXT}.

If step 720 determines that no normalization is needed, the method 710 may end. If step 720 determines that normalization is needed, the method 710 continues to step 722. In step 722, a normalized charge time is determined for the capacitor C_{EXT} relative to the modified charge time of the capacitor C_{REF}.

Accordingly, in step 724, a determination is made as to an amount of current I_{A} needed to normalize the charge time of the capacitor C_{EXT}, i.e., a coarse adjustment. It is understood that this may be an approximate current level that is simply intended to set I_{A} at an initial level that can be manipulated in either direction (lower or higher) as needed in order to match the charge time of the capacitor C_{EXT} with the charge time of the capacitor C_{REF} during a comparison.

In step 726, circuitry may be configured to provide the level of current I_{A} determined in step 722 to the capacitor C_{EXT}. For example, the current control circuitry 560 may be used to adjust the current level. It is understood that the current I_{A} may be controlled in many different ways, including direct current manipulation or by using many different types of circuits. The method 700 is directed to manipulating the current I_{A} in order to normalize the charge time of the capacitor C_{EXT} relative to the charge time of the capacitor C_{REF} and is not concerned with how the current is manipulated.

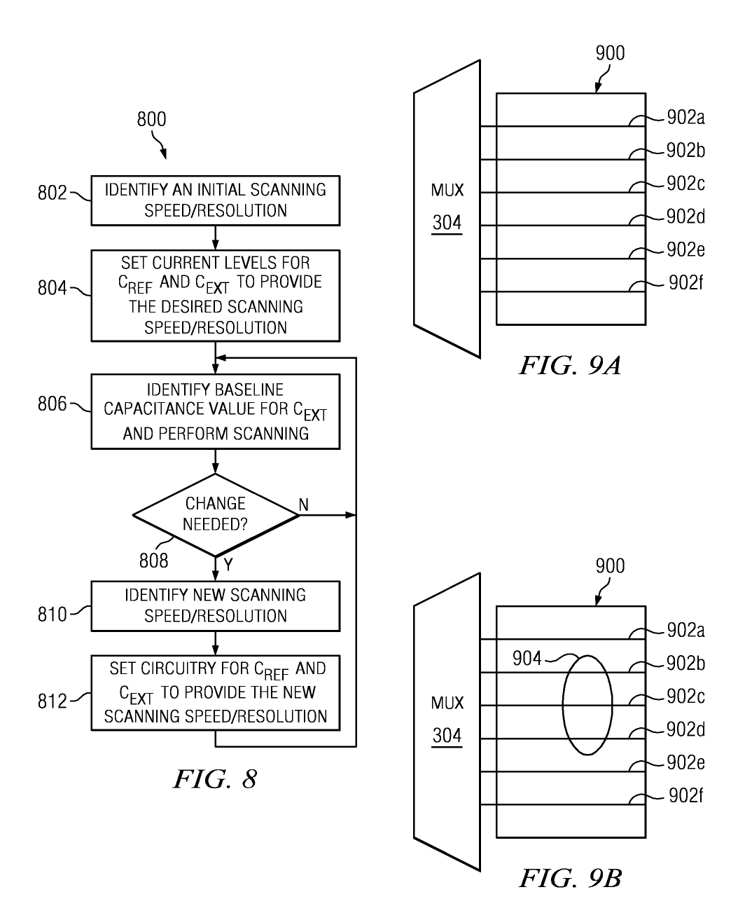

Referring to FIG. 8, one embodiment is illustrated of a flow chart depicting a method 800 by which the charging time of the capacitor C_{REF} of FIG. 5B may be adjusted multiple times to emphasize sensing speed or resolution depending on input or other criteria. In the present example, each adjustment occurs between actual comparisons, but it is understood that one or more of the adjustments may occur during a comparison in some embodiments.

The present example also refers to FIG. 9A, in which a simplified embodiment of a capacitive touch screen 900 is illustrated. The capacitive touch screen 900 includes six rows 902a-902f (columns are not shown). Each row 902a-902f will be representative of the transmission line 402 of FIG. 4A, and so will have a series of distributed capacitors 401 and associated series resistances (not shown) as described with respect to FIG. 4A. In the present example, no part of the touch screen 900 is more important from an application standpoint than any other part of the touch screen. However, if the side of the touch screen 900 near multiplexer 304 is of more interest than the side farthest away from the multiplexer, the touch screen may be scanned more rapidly and with higher resolution than if the opposite side is of more interest for reasons discussed above.

In step 802, an initial scanning speed/resolution may be identified. In the present example, the initial scanning speed is set to detect relatively large changes in capacitance and so will scan relatively rapidly and may miss small changes in capacitance. For example, the touch screen 900 may be associated with a device that can be activated from sleep mode via a touch on the touch screen, and so the scanning speed is set so that the capacitive sense block 306 can scan for a capacitance change that signals that the screen had been touched. Where the touch occurred (i.e., column/row information) on the touch screen 900 is not needed, only the fact that the screen was touched. For this reason, minor changes in capacitance can be ignored and the exact location is not necessary. It is understood that a touch occurring to the screen diametrically opposite the multiplexer 304 may result in a relatively small change in capacitance, but the circuitry may be adjusted to allow for a desired level of sensitivity to cover this situation.

In step 804, initial values are set for I_{B} and I_{A} in order to align the ramp voltages on C_{REF} and C_{EXT}, respectively, with the initial scanning speed identified in step 802. For example, this step may be performed as described previously using the method 710 of FIG. 7B. For this step, the coarse and fine settings are defined for I_{B} and the coarse setting is set for I_{A} at the nominal value for the current, and then the fine setting set at one end of the range therefor.

In step 806, once set, the baseline capacitance value for C_{EXT} may be determined and the scanning may be performed as described above.

In step 808, a determination is made as to whether a change is needed in the scanning speed. For example, detection of a capacitance change in the capacitance of one of the rows 902a-902f may trigger the determination of step 808. Continuing the current example, the change would need to be relatively large in order to be detected due to the relatively fast scanning speed selected in step 802.

If no change is needed, the method 800 returns to step 806. This loop may continue until a change is needed due to the detection of a change in capacitance or the scanning process is ended (e.g., the device is powered down). If a change is needed, the method 800 continues to step 810, where a new scanning speed/resolution may be identified. For example, an application may be programmed to detect a touch using the initial faster scanning speed/lower resolution scanning and, once a touch is detected, may be programmed to initiate a scan at a slower scanning speed/higher resolution in order to obtain more detailed information from that point forward. Alternatively or additionally, the application may initiate the lower scanning speed/higher resolution processing in order to gain additional information about the initial touch to the touch screen 900, as the time it takes a user to touch the screen with a finger and retract the finger may allow for multiple scans prior to the removal of the finger.

In step 812, new values are set for I_{B} and I_{A} in order to align the ramp voltages on C_{REF} and C_{EXT}, respectively, with the new scanning speed/resolution identified in step 808. Once set, the method 800 may return to step 806 and scanning may continue using the new scanning speed/resolution.

It is understood that the method 800 may be used to slow down and speed up the scanning speed, thereby increasing and decreasing the resolution, many times. Furthermore, the criteria used to determine whether to modify the scanning speed/resolution are limited only by the functionality provided by the touch screen 900.

Referring to FIG. 9B, another embodiment of the capacitive touch screen 900 of FIG. 9A is illustrated (where rows only are illustrated). In the present example, an area 904 has been defined on the touch screen 900. The area 904 may be defined by an application or may be otherwise defined. In this embodiment, the method 800 of FIG. 8 may be configured to scan the rows 902a, 902e, and 902f using a faster scanning speed/lower resolution while scanning the rows 902b-902d (i.e., the rows covering the area 904) at a slower scanning speed/higher resolution. Accordingly, the scanning speed/resolution may be modified between rows, with different rows scanned at different speeds and resolutions. This enables an application designer to designate areas of the touch screen 900 as more important than other areas and to tailor the scanning speed/resolution based on those areas. By defining the scanning speed and resolution, the application designer can customize the interface to provide desired functionality and can also provide power savings by not requiring each row to be scanned at a high resolution. Although not shown, it is understood that scanning may be further tailored by column, with slower/higher resolution scanning only occurring for certain column/row combinations. Further, only certain rows and columns associated with area 904 need be scanned to save power, etc. This may be because rows 902a, 902e and 902f are associated with rows of little or no interest.

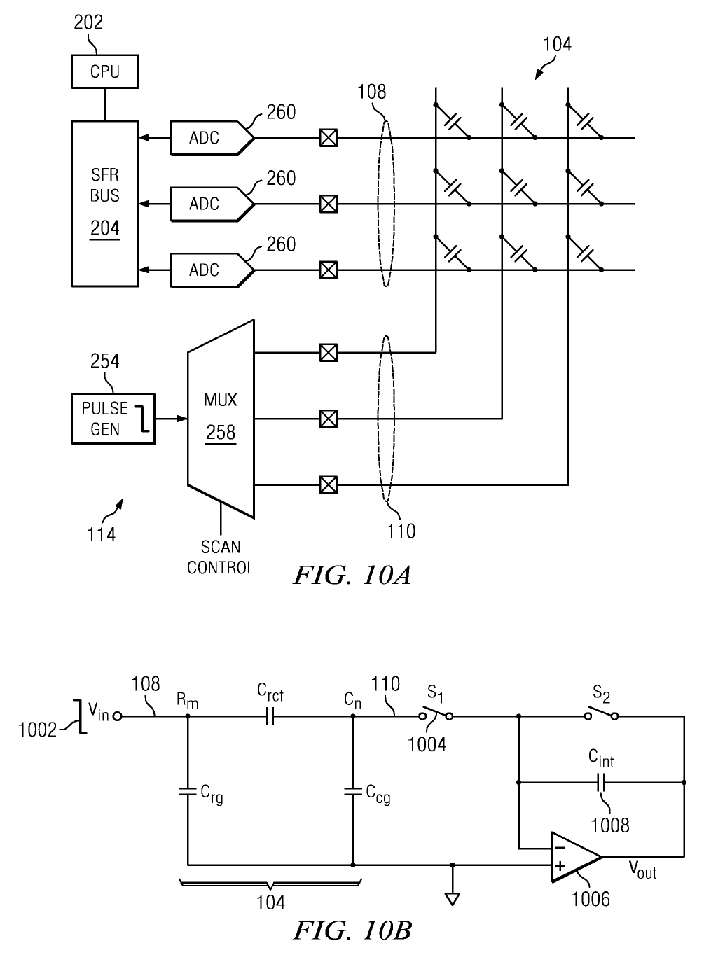

Referring now to FIG. 10A, there is illustrated a diagrammatic view of the MTR module 114 interfaced with the touch screen 104. There are illustrated only three rows 108 and three columns 110 for discussion purposes, it being understood that there could be multiple rows and columns in a particular touch screen 104. In this embodiment, the rows are each connected to a separate one of the ADCs 260 which, as described herein above, allows each row line to be sensed individually such that a high speed ADC is not required for individually scanning the analog voltage and the output of a row line with a switched multiplexer. For the generation of the pulse, a single pulse must be generated for each column line 110. Therefore, when a pulse is generated on a particular column line, it will be coupled across to the row line and the voltage on the particular row line measured by the associated ADC 260 and this value latched in the output for reading by the CPU 202.

Referring now to FIG. 10B, there is illustrated a simplified diagram of the MTR circuit. A pulse 1002 is generated by the pulse generator 254 for a particular row line 108. The touch screen 104 for a particular row and column line intersection is illustrated with a capacitance disposed between the row line and ground labeled C_{RG}. The column line 110 has a capacitor C_{CG} connected between the column line and ground. The pulse 1002 is a negative going pulse, in this embodiment, which drives the row line and is coupled across to the column line 110 via a coupling capacitor C_{REF} between the row and column line. A switch 1004 is operable to connect the column line to the input of an amplifier 1006, on the negative input thereof, the positive input connected to ground. When this is connected to the negative edge, a feedback capacitor 1008 disposed between the negative input of amplifier 1006 and the output thereof labeled C_{ind} will result in a trapped charge being disposed thereon. Each of these blocks (there being one block for each of the ADCs 260) will individually trap the signal such that opening of switch 1004 causes it to be latched. The goal is to sense minute changes (˜5 pF) at Crg caused by the approach of a human finger. A single row or column pulse will be simultaneously captured on the column line 110. This pulse will be repeated for each column. 0 to 100 pF is the approximate working range therefor.

During scanning, the user is provided a great deal of versatility in how to scan the touch screen. For example, if there are twenty receivers, the user can choose to: a) read odd numbered receivers, followed by even number receivers; or b) read #0 to #15 receivers first, then read the rest of the four lines; or c) only use a certain number of the MTRs to read certain lines. The user could start the driver or pulse generator from #0 row and move up sequentially, or start from a random number, for example #6, then drive #5, #7, #8, #4, etc. This allows the multi-touch resolve system to focus on a particular area of the touch screen 104 and, even one intersection of a row and column in a particular panel if a user so desired. By so doing, power can be significantly reduced in that less time is required to scan only a portion of the touch screen 104, thus requiring the CPU 202 to be “awake” for less time.

It will be appreciated by those skilled in the art and having the benefit of this disclosure that the capacitive sense circuit and methods described herein provide a flexible solution to provide configurable capacitive sensing capabilities for a capacitive sensor array. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A circuit for controlling current comprising:
first circuitry for controlling a first current provided to a reference capacitor having a known capacitance, wherein the first current determines a charge time defining an amount of time required for the first current to fully charge the reference capacitor and wherein alteration of the first current alters the charge time of the reference capacitor;
second circuitry for controlling a second current to an external capacitor having an unknown capacitance, wherein the second current determines a charge time of the external capacitor and wherein alteration of the second current alters the charge time of the external capacitor; and
control logic configured to receive input defining a period of time at which to set the charge time of the reference capacitor, control the first circuitry to provide a minimum amount of the first current needed to charge the reference capacitor within the defined period of time, and control the second circuitry to provide an amount of the second current needed to normalize the charge time of the external capacitor with the charge time of the reference capacitor.

2. The circuit of claim 1 wherein the first circuitry comprises a first current mirror coupled to a first current source providing the first current and a first plurality of attenuators coupling the first current mirror and the reference capacitor, wherein each of the first plurality of attenuators is controllable by the control logic.

3. The circuit of claim 2 wherein the first plurality of attenuators are transistors arranged in a binary weighted manner.

4. The circuit of claim 3 wherein the minimum amount of the first current is based on a resolution provided by the first plurality of attenuators.

5. The circuit of claim 2 wherein the control logic further includes a register configured to provide control bits corresponding to each of the first plurality of attenuators, wherein each of the control bits indicates whether the corresponding attenuator should be added to or removed from a current path providing the first current from the first current source to the reference capacitor.

6. The circuit of claim 2 wherein the second circuitry comprises a second current mirror coupled to a second current source providing the second current and a second plurality of attenuators coupling the second current mirror and the external capacitor, wherein each of the second plurality of attenuators are controllable by the control logic.

7. The circuit of claim 1 wherein the control logic is further configured to match the charge time of the reference capacitor with the charge time of the external capacitor in order to set a baseline value to detect changes in capacitance of the external capacitor.

8. The circuit of claim 1 further comprising third circuitry for controlling a third current to a third capacitor providing a clock signal to the control circuitry, wherein the third current determines a discharge rate of the third capacitor and wherein alteration of the third current alters the discharge rate of the third capacitor.

9. The circuit of claim 8 wherein the third circuitry comprises a plurality of transistors controllable by the control logic, and wherein the transistors are arranged in a binary weighted manner.

10. A circuit comprising:
first circuitry configured to match a charge time of a reference capacitor with a charge time of an external capacitor in order to set a baseline value to detect changes in capacitance of the external capacitor, wherein the first circuitry includes the reference capacitor having a known capacitance and wherein the charge time of the reference capacitor defines an amount of time needed to fully charge the reference capacitor and is based on a first current provided to the reference capacitor by the first circuitry via a first current source;
second circuitry configured to control a variable second current source providing a second current to the external capacitor having a unknown capacitance, wherein the second current determines the charge time of the external capacitor; and
control logic configured to receive input defining the charge time for the reference capacitor, control the first circuitry to provide an amount of the first current needed to charge the reference capacitor within the defined charge time, and control the second circuitry to match the charge time of the external capacitor with the defined charge time of the reference capacitor by varying the second current provided by the second current source.

11. The circuit of claim 10 further comprising control logic configured to control the second circuitry to provide an amount of the second current needed to normalize the charge time of the external capacitor with the defined charge time of the reference capacitor, wherein the variable second current source maintains a constant current level during the normalizing.

12. The circuit of claim 10 wherein the first circuitry comprises a plurality of transistors each configured to be added to or removed from a path of the first current by the control logic in order to alter the first current provided to the reference capacitor.

13. The circuit of claim 12 wherein the plurality of transistors are arranged in a binary weighted manner.

14. The circuit of claim 13 wherein the each of the plurality of transistors are coupled to the reference capacitor via a switch, and wherein each of the switches is controlled by a bit from the control logic.

15. A method comprising:
identifying a scanning speed at which a capacitive touch screen is to be scanned, wherein the scanning speed represents an amount of time allocated to scan a single row or column of the capacitive touch screen;
determining a charge time corresponding to the identified scanning speed for a reference capacitor having a known value, wherein the reference capacitor is associated with scanning circuitry and wherein the charge time is one of a plurality of configurable charge times available to the reference capacitor;
determining a level of a first current needed to fully charge the reference capacitor within the determined charge time; and
configuring circuitry to provide the first current at the determined level to the reference capacitor, wherein the scanning speed is set by the charge time of the reference capacitor.

16. The method of claim 15 further comprising identifying a baseline capacitance value for an external capacitor associated with the capacitive touch screen by altering a current provided to the external capacitor via a variable current source until a charge time of the external capacitor matches the determined charge time of the reference capacitor.

17. The method of claim 16 further comprising scanning the touch screen at the identified scanning speed to detect actuation of the external capacitor based on a difference in a detected capacitive value of the external capacitor and the baseline capacitance value.

18. The method of claim 16 further comprising determining whether the charge time of the external capacitor needs to be normalized with the determined charge time of the reference capacitor.

19. The method of claim 18 further comprising, if the charge time needs to be normalized, determining a level of a second current needed to charge the external capacitor in the normalized charge time and configuring circuitry to provide the second current at the determined level to the external capacitor, wherein the variable current source is not used to alter the second current during the normalizing.

20. The method of claim 15 further comprising:
determining if a change in the scanning speed is needed;
identifying a new scanning speed at which the capacitive touch screen is to be scanned if a change in the scanning speed is needed;
determining a new charge time for the reference capacitor corresponding to the identified new scanning speed;
determining a new level of the first current needed to fully charge the reference capacitor in the determined new charge time; and
configuring circuitry to provide the first current at the determined new level to the reference capacitor.

21. The method of claim 15 further comprising:
identifying a first portion of the touch screen that is to be scanned at the identified scanning speed and identifying a second portion of the touch screen that is to be scanned at a new scanning speed;
determining a new charge time for the reference capacitor corresponding to the new scanning speed;
determining a new level of the first current needed to charge the reference capacitor in the determined new charge time;
configuring circuitry to provide the first current at the determined new level to the reference capacitor; and
scanning the first and second portions of the touch screen at the identified scanning speed and the new scanning speed, respectively.
